(19) United States
(12) Patent Application Publication
(10) Pub. No.: US 2009/0175567 A1
(43) Pub. Date: Jul. 9, 2009

(54) CAM FOLLOWERS FOR LONG LIFE

(75) Inventors: James Prescavage, Hainesport, NJ (US); Robert Lugosi, Oxford, CT (US)

Correspondence Address: MICHAUD-DUFFY GROUP LLP, 306 INDUSTRIAL PARK ROAD, SUITE 206, MIDDLETOWN, CT, 06457, US

(73) Assignee: ROLLER BEARING COMPANY OF AMERICA, INC., Oxford, CT (US)

(21) Appl. No.: 12/351,036

(22) Filed: Jan. 9, 2009

Related U.S. Application Data
(60) Provisional application No. 61/019,956, filed on Jan. 9, 2008.

(51) Int. Cl. F16C 19/28

(52) U.S. Cl. 384/447

(57) ABSTRACT

A cam follower assembly has an outer race and an inner race located therein. Rollers are located between the outer and inner races to enable the two races to rotate relative to one another. The surfaces of the inner race are lapped and subsequently treated using a cold plastic deformation process. This process is a dry mechanical process that involves applying a high energy flow of abrasive material in a carrier medium to the metal surfaces of the inner race. The present invention is not limited to treatment of the surfaces of the inner race, however, as the surfaces of the outer race as well as the surfaces of the rollers may be similarly treated.

### CROSS-REFERENCE TO RELATED APPLICATION

This application claims the benefit of U.S. Provisional Application No. 61/019,956 filed Jan. 9, 2008, which is incorporated herein by reference.

### FIELD OF THE INVENTION

This invention relates to roller bearings and, more particularly, to roller bearings for use as cam followers which have an increased life.

### BACKGROUND OF THE INVENTION

A roller bearing typically comprises rollers that are held between an inner race and an outer race. The rollers are cylindrically-shaped elements that facilitate the rolling engagement of the inner race relative to the outer race. Plain roller bearings include rollers that are right circular cylinders and are mounted in races in which the outer surfaces thereof are parallel to the axis of rotation of the rollers. When the rollers are very long and thin (as compared to other rollers), the rollers are typically referred to as “needle bearings.” When the rollers are conical in shape and run on races having conical surfaces, the bearings are typically referred to as “tapered roller bearings.” The rollers of both plain roller bearings and needle bearings are better suited for accommodating radial loading than axial loading. Tapered roller bearings are designed to accommodate both axial and radial loading. In any roller bearing, there may be any number of rows of longitudinally positioned rollers.

Cams are rotating wheels that are used to convert rotary motion into linear motion. The peripheral edge or profile of the wheel includes one or more protrusions, recessions, or the like such that when the wheel rotates, a point on the profile moves in a non-circular path. The non-circular movement of this point can be used to drive an element in the linear motion via a cam follower.

Cam followers are devices that are specifically designed to follow the profile of a cam when the cam is rotated. While a cam follower can be any device that is suitably supported to trace and move in response to being driven by the profile of the cam, the types of cam followers widely employed in industrial applications typically utilize assemblies of roller bearings that are mounted axially on a stud that is supported at one end thereof. Other types of cam followers utilize yoke-type arrangements or clevis mounting to support the roller bearing assemblies.

In a cam follower, the inner race is in contact with the stud (or a shaft in the yoke-type arrangement or clevis). The outer race is fixedly mounted within or on a wheel or other rolling device. As the cam follower traces the profile of a cam, the roller bearings, which generally have higher radial load capacities than ball bearings, distribute the radial load applied as a result of the tracing of the profile of the cam and allow for the free rotation of a wheel or other rolling device. However, as the cam turns and the profile is traced, there is a tendency to push the cam follower to one side. The distribution of the radial load and the ease with which the wheel or other rolling device can rotate on the roller bearings, therefore, has a direct effect on the efficiency of the transfer of the rotary motion into the linear motion.

In roller bearing assemblies, as well as in all bearing assemblies, various factors can contribute to bearing failure. These factors include, but are not limited to, excessive loading, misalignment of the bearing, contamination, corrosion, lubrication failure, and improper (loose or tight) fitting. When any of these factors are encountered during the operation of a bearing assembly, one condition that may occur is deformation of the bearing. When the bearing deforms, surfaces of either or both the rolling elements and the races can shear and weld together, thereby interrupting the operation of the device in which the bearing is incorporated and possibly damaging the components. Another condition that may occur is spalling (also known as fatigue failure). Spalling is generally a progressive condition that can be detected by monitoring vibration. When spalling occurs, the contacting surfaces of the bearing fracture, and small amounts of material are displaced, which will eventually lead to bearing failure if not addressed.

### SUMMARY

In one aspect, the present invention resides in a cam follower assembly having an outer race and an inner race located therein. Rollers are located between the outer and inner races to enable the two races to rotate relative to one another. The surfaces of the inner race are lapped and subsequently treated using a cold plastic deformation process. This process is a dry mechanical process that involves applying a high energy flow of abrasive material in a carrier medium to the metal surfaces of the inner race. The present invention is not limited to treatment of the surfaces of the inner race, however, as the surfaces of the outer race as well as the surfaces of the rollers may be similarly treated.

One advantage of the present invention is that the treatment of the surfaces of the cam follower assembly produces longer-life bearing components. The lapped surfaces of the inner race, when also treated with the cold plastic deformation process, eliminate or at least substantially reduce the incidences of spalling that occur in the cam follower assembly. While not being bound by any particular theory, it is speculated that lapping the surfaces of the inner race followed by the application of abrasive material in a carrier medium compresses and weaves together existing surface fractures and prevents or at least minimizes the occurrences of additional fractures in the running surfaces of the bearing, which thereby reduces the fatiguing of the metal.

Another advantage of the present invention is that improved resistance to corrosion is realized. Improved corrosion resistance is due to the reduction of chemical interaction between the metal surface of the inner race and environmental corrosive elements. While not being bound by any particular theory, it is speculated that the cold plastic deformation process either reduces the surface area of the metal, thereby providing less surface area for contact with environmental elements, or compacts the geometric structure of the metal surface, thereby leaving fewer (or no) areas for environmental impurities to infiltrate and bind to.

### DESCRIPTION OF THE DRAWINGS

FIG. 1 is a side view of a cam follower assembly of the present invention.

FIG. 2 is a side view of the assembly of the inner race located in the outer race.

FIG. 3 is a front view of the assembly of FIG. 2.

FIG. 4 is a side view of the inner race.

FIG. 5 is a front view of the inner race of FIG. 4.

### DETAILED DESCRIPTION OF THE PREFERRED EMBODIMENT

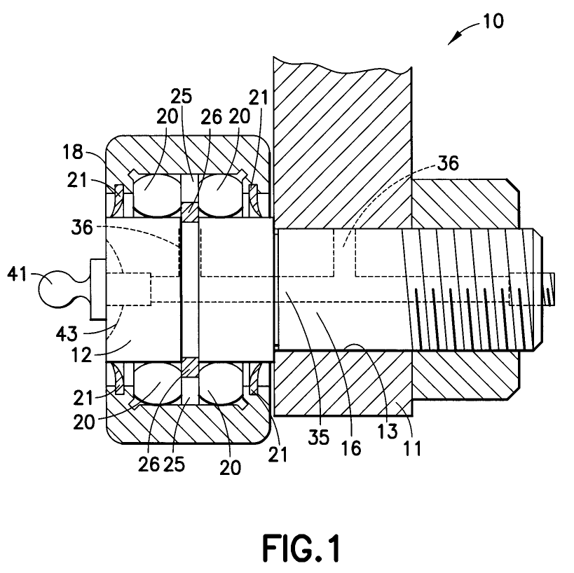

As is shown with reference to FIG. 1, a cam follower assembly is designated generally by the reference numeral 10 and is hereinafter referred to as “assembly 10.” Assembly 10 comprises an inner race 12 located axially in an outer race 18. Rollers 20 are positioned between the inner race 12 and the outer race 18 such that the inner race and the outer race can rotate relative to each other. A split ring 26 is positioned in a space 25 between the rollers 20. Seals 21 are located in the outer race 18 and provide wiping communication with the inner race 12.

The assembly is carried by a shaft 16, which is mounted in a bore 13 in a carrier member 11. The shaft 16 is shown as being threaded; however, the present invention is not limited in this regard, as the shaft may be press-fit into the carrier member 11 or retained therein by any other suitable method.

A lubrication fitting 41 may be located on one or both ends of the shaft 16 to allow for the introduction of lubricant into an optional lubrication channel 35 that extends lengthwise along the shaft. Transversely-oriented lubrication channels 36 extend from the lubrication channel 35 to provide lubricant to the surface of the bore 13 in the carrier member 11 and to the rollers 20 between the inner race 12 and the outer race 18. A slot 43 may be provided for facilitating the mounting and removal of the assembly 10 using a suitable tool (e.g., a screwdriver or the like). The present invention is not limited to the use of a slot for facilitating the mounting and removal of the assembly, however, as other mechanisms (e.g., hex holes or the like) may be used.

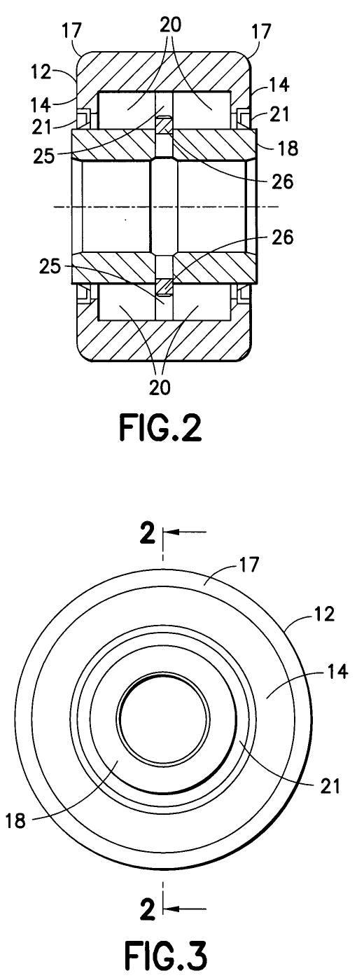

As is shown with reference to FIGS. 2 and 3, the outer race 12 is cylindrically-shaped and includes inwardly-extending flanges 14 at the ends thereof. The ends of the flanges 14 define openings that further define a bore that extends longitudinally through the outer race 12. Peripheral edges 17 of the outer race 12 may be rounded to have a radius. The inner race 18, which is also cylindrically-shaped, is located within the bore extending through the outer race 12.

The seals 21 are located at opposing end of the outer race 12 and on the outer surfaces of the flanges 14. The seals 21 are disposed in a channel or similar cut out area that extends circumferentially around the openings that define the bore extending through the outer race 12. These seals 21, which may have single or multiple sealing lips, provide a wiping motion on the outer surface of the inner race 18 and assist in retaining lubricant between the rollers 20 and the inner race 18. The seals 21 also may prevent the ingress of contaminants between the rollers 20 and the inner race 18.

The rollers 20, which are cylindrically-shaped (and may be right circular cylinders or conical cylinders), are located in an annular space between the outer race 12 and the inner race 18 and between the inwardly-extending flanges 14. The rollers 20 are arranged in two rows with the first row being disposed against an inner surface of one flange 14 and the second row being disposed against an inner surface of the flange 14 at the opposing end of the outer race 12. The present invention is not limited in this regard, however, as three or more rows of rollers may be located between the flanges 14. When two or more rows are used, the space 25 is defined between each row. Also, the present invention is not limited to multiple rows of rollers 20, as there may be only one row of rollers.

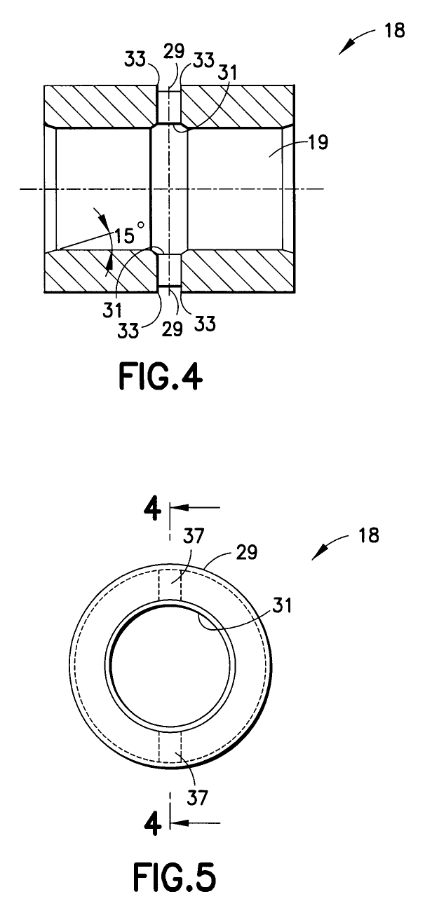

When two or more rows of rollers 20 are located in the outer race 12, the split ring 26 is provided between the rows of rollers and in an outer groove (shown at 29 in FIG. 4) around the outer surface of the inner race 18. The split ring 26 is a ring having a radial opening therein, which thereby allows the ring to flex slightly to allow it to be stretched open over the periphery of the inner race 18. Once the split ring 26 is stretched over the periphery of the inner race 18 and the inner race is assembled in the outer race 12, the split ring resides in the outer groove 29. Preferably, the inside surface of the split ring 26 is slightly larger than the circumference of the outer groove 29 in which the split ring is carried and the split ring is narrower than the outer groove.

As is shown with reference to FIG. 4, the inner race 18 is substantially cylindrical in shape and includes a bore 19 extending therethrough. The edges that define the opening of the bore 19 are chamfered at an angle (e.g., about 15 degrees). An inner groove 31 is formed in the surface that defines the bore and is substantially centered between the ends of the inner race 18. The outer groove 29 is formed in the outer surface of the inner race 18 and is substantially centered between the ends of the inner race. The outer groove 29 is defined by sharp corners 33 on the edges thereof to maintain the split ring 26 in position and to minimize axial movement of the split ring.

As is shown with reference to FIG. 5, the outer groove 29 and the inner groove 31 of the inner race 18 are in communication with each other via through holes 37. These through holes 37 extend perpendicular to the bore extending longitudinally through the inner race 18. As shown, two through holes 37 are located in the inner race 18, each being at opposing sides of the bore. The through holes 37 allow for the lubrication of the assembly 10, namely by the injection of lubricant into the bore 19.

The outer surface of the inner race 18 is lapped and further treated to improve surface quality. This further treatment is a dry mechanical process involving cold plastic deformation of the metal proximate the outer surface. The cold plastic deformation is imparted to the metal using a high energy flow of abrasive material in a carrier medium. The application thereof, particularly on the outer surface and in underlying layers of the metal, weaves together surface fractures in the metal. In particular, the application shifts the fault lines in the metal from linear configurations to interwoven configurations while increasing the hardness of exposed surface features.

When the cold plastic deformation is applied to the metal on the outer surface of the inner race 18, the metal on the outer surface has a pattern of channels that are substantially evenly distributed. This substantially even distribution of channels imparts hydrodynamic effects to the outer surface and may further facilitate the adhesion of lubricant.

The present invention is not limited to the cold plastic deformation of the metal of the outer surface of the inner race 18, however, as the inner surface of the outer race 12 may be similarly treated. Furthermore, any surfaces of the outer race 12, particularly those adjacent the rollers 20 as well as the surfaces of the rollers themselves may be treated as described herein.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of the appended claims.

What is claimed is:

1. A cam follower assembly, comprising:
an outer race having a cylindrical shape and inwardly-extending flanges at opposing ends of said outer race, said inwardly-extending flanges defining a bore through said outer race;
an inner race located in said bore of said outer race and defining an annular space between said inner race and said outer race, said inner race having an outer surface that faces said outer race; and
a plurality of rollers longitudinally positioned in said annular space;
wherein said outer surface of said inner race that faces said outer race is lapped and treated with a cold plastic deformation process.

2. The cam follower assembly of claim 1, wherein surfaces of said rollers are treated with said cold plastic deformation process.

3. The cam follower assembly of claim 1, wherein at least one surface of said outer race is treated with said cold plastic deformation process.

4. The cam follower assembly of claim 1, wherein said plurality of rollers comprises two rows of rollers, each row being longitudinally positioned in said annular space.

5. The cam follower assembly of claim 4, further comprising a split ring located between said two rows of rollers.

6. The cam follower assembly of claim 1, further comprising a lubricant located in said annular space.
